(19) United States
(12) Patent Application Publication
(10) Pub. No.: US 2007/0041448 A1
(43) Pub. Date: Feb. 22, 2007

(54) Artifact and noise reduction in MPEG video

(76) Inventors: Casey L. Miller, Fort Collins, CO (US); James W. Owens, Fort Collins, CO (US); Ramin Samadani, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/206,453

(22) Filed: Aug. 17, 2005

(51) Int. Cl. H04N 11/04

(52) U.S. Cl. 375/240.18

(57) ABSTRACT

A method and apparatus for improving the quality of MPEG video are disclosed. In a preferred embodiment, a group of pictures (GOP) is obtained and decompressed, producing an initial decompressed GOP. This initial decompressed GOP is spatially shifted to at least two shift positions. At each shift position, MPEG compression and decompression are applied, producing a resulting decompressed GOP for each shift position. The resulting decompressed GOPs are shifted back to their initial position and combined, preferably by averaging, to form an improved GOP.

### FIELD OF THE INVENTION

The present invention relates to digital video processing, and more specifically to artifact and noise reduction in MPEG video.

### BACKGROUND

MPEG is a name given to a set of international standards used for compressing and encoding digital audiovisual information. MPEG stands for Motion Picture Experts Group, the group who originally formulated the standards. Several standards have emerged and been promulgated by the International Standards Organization (ISO), including MPEG-1, MPEG-2, and MPEG-4, more formally known as ISO/IEC-11172, ISO/IEC-13818, and ISO/IEC-14496 respectively. For the purposes of this disclosure, “MPEG” means any image coding scheme meeting any of these standards or operating in a similar way. In general, MPEG algorithms perform block transforms (usually a discrete cosine transform or “DCT”) on blocks selected from frames of digital video, quantize each resulting coefficient set, and efficiently encode the coefficients for storage. An MPEG video sequence can be replayed by reversing the steps used for compression and rendering the resulting decompressed video.

Because MPEG performs “lossy” compression, the sequence recovered after compression and decompression differs from the original uncompressed sequence. These differences are sometimes called distortion. Generally, the amount of distortion introduced increases with increasing compression ratio, and artifacts of the distortion are often visible in the decompressed video sequence. For example, the edges of the blocks selected for the block transforms may be visible, and the decompressed sequence may appear “noisy”, often because visual edges within a frame have “ringing” or halo artifacts. More information about MPEG can be found in MPEG Video Compression Standard, edited by Joan L. Mitchell, William B. Pennebaker, Chad E. Fogg, and Didier J. LeGall, and published by Chapman & Hall, ISBN 0-412-08771-5.

Similar distortion issues arise in compressing and decompressing still images using the JPEG standard, named for the Joint Photographic Experts Group, the committee that developed the specifications for standard use of the technique and for the standard file format of JPEG image files. Various techniques have been devised for improving the quality of images reconstructed from JPEG files. For example, Nosratinia describes an algorithm in which a decompressed JPEG image is further processed by repeatedly shifting it spatially with respect to the block grid used for performing the block transforms, performing JPEG compression and decompression on each of the shifted images, shifting each back to its nominal position, and then averaging the resulting images. (See A. Nosratinia. “Enhancement of J PEG-compressed images by re-application of JPEG,” Journal of VLSI Signal Processing Systems for Signal, Image and Video Technology, vol. 27, pp. 69-79, February 2001.)

However, these techniques devised for still images generally perform poorly on some MPEG video frames, especially those predicted or interpolated from other frames.

### BRIEF DESCRIPTION OF THE DRAWINGS

FIG. 1 shows a flowchart of a method in accordance with an example embodiment of the invention for improving the quality of an MPEG video sequence.

FIG. 2 illustrates the division of a video frame into macroblocks for the purposes of MPEG compression.

FIG. 3 shows a frame in a shifted position, in accordance with an example embodiment of the invention.

FIG. 4 illustrates the combination of resulting decompressed groups of pictures, in accordance with an example embodiment of the invention.

FIG. 5 depicts a block diagram of a digital camera configured to perform a method in accordance with an example embodiment of the invention.

FIGS. 6A and 6B depict the ordering of performing steps in two methods in accordance with example embodiments of the invention.

### DETAILED DESCRIPTION

Three different kinds of encoded frames may be used in constructing an MPEG video sequence. An “I-frame” is said to be intracoded. That is, the compressed frame is derived entirely from a single uncompressed frame of digital video, without regard to any other frames.

A “P-frame” is said to be predictively coded. In a P-frame, particular macroblocks of data are encoded differentially based on the most recent previous I- or P-frame. Some motion estimation is also encoded into a P-frame. To encode a particular macroblock in a P-frame, a region of the most recent previous I- or P-frame is searched to locate a macroblock that is similar to the current macroblock to be compressed and encoded. An array of pixel differences between that previous macroblock and the current block is computed, and that difference array is then quantized and encoded for storage. Motion vectors pointing to the location of the previous macroblock are also stored, so the current macroblock can be reconstructed.

A “B-frame” is said to be bi-directionally coded. That is, a B-frame is defined in reference to another I- or P-frame, but the reference frame may come temporally before or after the current frame being coded as a B-frame. Alternatively, a B-frame may be defined in reference to both a past I- or P-frame and a future I- or P-frame.

Various parameters may be specified for controlling the frame encoding. The size of the area to search in another frame for locating a similar macroblock for differential coding may be specified as well as the resolution with which to search. For example, a search may cover an area including all macroblocks within a specified distance from the location of the current macroblock in the current frame, in full-pixel increments, half-pixel increments, or quarter-pixel increments. The specified distance may be, for example ±16 pixels in each orthogonal direction, or some other distance. These specified parameters may be called a motion vector search range and a motion vector resolution. Additionally, the sequence of frame types, a bitrate, and rate control parameter settings may be specified. Optimal settings will depend on the particular application, and the desired tradeoff between compression ratio, speed, and image quality.

An MPEG video sequence is an interleaved set of frames, almost any of which may be I-frames, P-frames, or B-frames. For example, a video sequence could be stored using only I-frames. However, improved compression is possible if some P-frames are used, and still better compression is possible if B-frames are used as well. No particular ordering of I-, P-, and B-frames is specified. One commonly-used arrangement is to group fifteen frames together in the sequence IBBPBBPBBPBBPBB, and then repeat the sequence throughout the MPEG file. Each of these groups including an I-frame and the subsequent B- and P-frames occurring before the next I-frame is called a “group of pictures”, or GOP. A GOP that can be decompressed without referring to any frame outside the GOP is called a “closed GOP”. A GOP that includes I-frames as the first and last frames in the GOP is an example of a closed GOP. A GOP that begins or ends with a B-frame is an example of an “open GOP”, because frames outside the GOP are referred to in decompressing the GOP. Preferably, but not necessarily, a method in accordance with an example embodiment of the invention operates on a closed GOP.

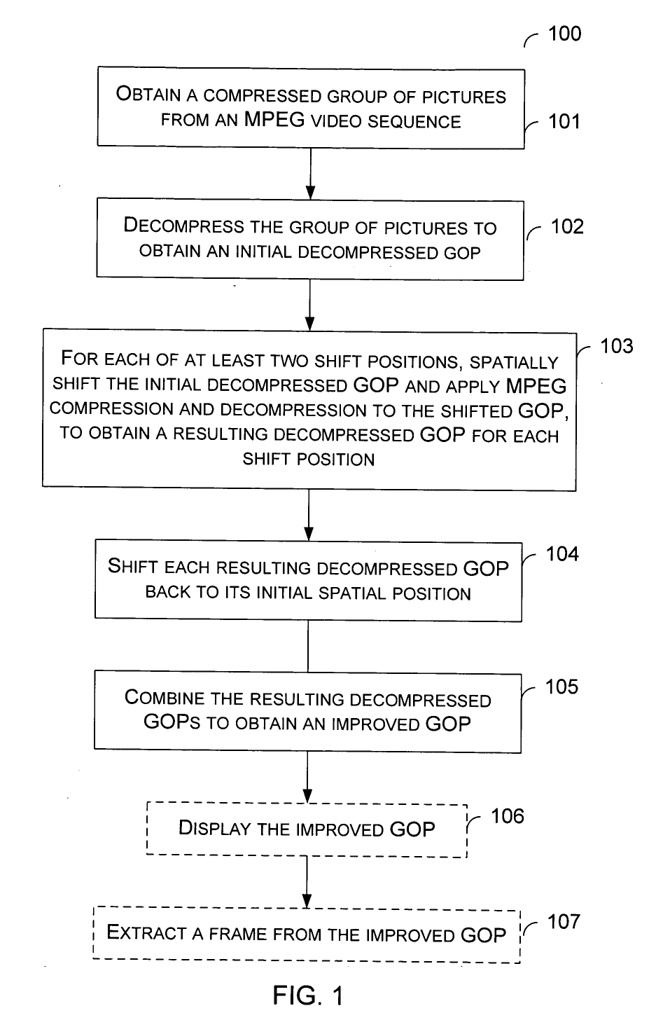

FIG. 1 shows a flowchart of a method 100 in accordance with an example embodiment of the invention for improving the quality of an MPEG video sequence. In step 101, a compressed GOP is obtained from an MPEG video sequence. In step 102, the GOP is decompressed. The result is an initial decompressed GOP.

In step 103, the initial decompressed GOP is further processed as follows. For at least two shift positions, the initial decompressed GOP is spatially shifted in relation to the grid used to define macroblocks. MPEG compression and decompression are applied to the GOP in each shift position. This results in a resulting decompressed GOP for each shift position.

In step 104, each resulting decompressed GOP is spatially shifted back to the initial position. In step 105, the resulting decompressed GOPs are combined into an improved GOP. In optional step 106, the improved GOP is displayed. (At least some optional steps are indicated in FIG. 1 by a dashed boundary around the corresponding process block.) In optional step 107, a frame is extracted from the improved GOP. The extracted frame may be used as a still image for printing, display, transmission, or for other purposes.

Several of the steps in the method of FIG. 1 will now be described in greater detail.

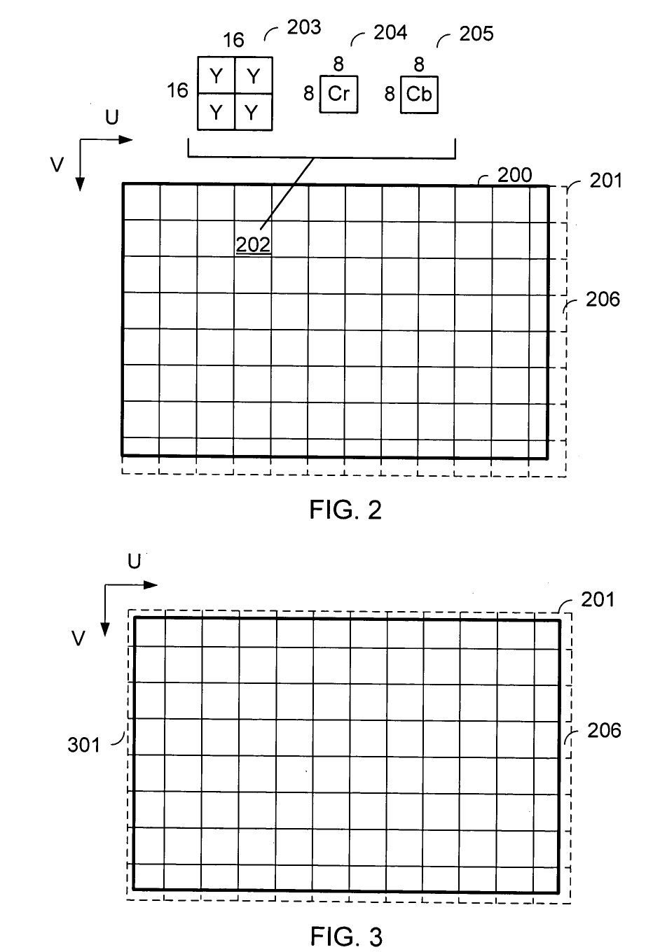

FIG. 2 illustrates the division of a video frame into macroblocks for the purposes of MPEG compression. Example frame 200 is 184 pixels wide and 120 pixels high. Superimposed on image 200 is a grid 201 of macroblock boundaries. Each example macroblock covers an area 16×16 pixels square on image 200. When a frame is not a multiple of 16 pixels in width or height, macroblocks that extend beyond the frame boundaries may be padded with zeros so that the frame is completely covered by macroblocks, and each macroblock is 16×16 pixels square. In FIG. 2, frame 200 is not a multiple of 16 pixels wide or high, so edge macroblocks such as macroblock 206 may be padded with zeros.

Original frame 200 may be captured by a digital camera or other imaging device in RGB format, wherein each pixel is described by three numerical values, one each representing the red, green, and blue components of the image at that pixel. An early step in MPEG compression converts the digital data to YCrCb format, which includes a luminance channel Y and two chrominance channels Cr and Cb. The two chrominance channels are downsampled so that the macroblock is represented by four 8×8 pixel luminance blocks and two 8×8 pixel chrominance blocks. In FIG. 2, the contents of macroblock 202 are shown to be a 16×16 pixel array 203 of luminance values (four 8×8 arrays) and two 8×8 arrays 204, 205 of chrominance values.

In FIG. 2, frame 200 is shown in its initial position, with the macroblock boundaries aligned with the upper left corner of frame 200. FIG. 3 shows frame 200 in a shifted position. Frame 200 has been shifted in relation to macroblock grid 201 by about two pixels in the horizontal (+U) direction, and about three pixels in the vertical (+V) direction. For the purposes of this disclosure, a shift of frame 200 in relation to grid 201 may also be thought of or implemented as a shift of grid 201 in relation to frame 200. The shift may be entirely conceptual. A processor or other device implementing the method may actually move data in memory, or may use an algorithm that does not require data movement. Whatever particular algorithm is used, the result is that when MPEG compression and decompression are applied to a shifted frame in step 103, the macroblock boundaries fall in different locations than when the frame is in its initial position.

While FIG. 2 shows only frame 200, in accordance with method 100 an entire GOP is shifted. In one preferred embodiment, the GOP is shifted to all positions having a U-direction (horizontal) shift of between −3 and +4 pixels inclusive, and a V-direction (vertical) shift of between −3 and +4 pixels inclusive. That is, a total of 64 shift positions are preferably used, including the initial position, which has a (U,V) shift of (0,0). Other combinations are possible as well. For example, not all of the shifts in the above pattern need be used; the shifts could be performed in a checkerboard or quincunx pattern, omitting all even- or odd-numbered shift positions.

Unfilled macroblocks that overlap edges of the frame, for example macroblocks 206 and 301 in FIG. 3, may be handled in any appropriate manner. For example, each unfilled area may be padded with zero values, or may be filled with data copied from the nearest available macroblock column or row inside the frame.

Also in step 103 of method 100, compression and decompression are applied to the GOP in each of the shifted positions. The result is a resulting decompressed GOP for each shift position. The compression and decompression may be full MPEG processing, or may be a subset chosen for computational efficiency.

Full MPEG compression and decompression of a GOP comprises several steps. In one example embodiment, the steps may be summarized by the table below.
1. Choose a sequence of I-, P-, and B-frames
2. Compute residual blocks and motion vectors for P- and B-frames
3. For each frame, perform the following steps:
   a. Color space conversion
   b. Downsampling of the chrominance channels
   c. Performing a Discrete Cosine Transform (DCT) on each block
   d. Quantization
   e. “Zig zag” ordering of the quantized coefficients of each block
   f. Differential coding of the DC coefficient from the DCT
   g. Run-length coding of the AC coefficients from the DCT
   h. Variable-length coding of the coefficients from the DCT

Full MPEG decompression comprises complementary steps, performed in approximately reverse order:
1. For each frame, perform the following steps:
   a. Interpreting the differential codes to reconstruct the DC coefficient
   b. Interpreting the variable-length and run-length codes to reconstruct AC coefficients of each block
   c. Placing the coefficients in block order
   d. Array multiplication (inverse quantization)
   e. Performing an inverse DCT on each block
   f. Upsampling the chrominance channels
   g. Color space conversion
2. Populate P- and B-frames based on residuals, motion vectors, and other frames

In one example embodiment of the present invention, each shifted GOP is subjected to full MPEG compression and decompression. This may be a preferred implementation when an MPEG engine is available but not readily modifiable. For example, an MPEG engine may be implemented in hardware or in a software library routine.

If a custom implementation is possible, then preferably some portions of MPEG processing are omitted for computational efficiency. For example, the color space conversion and downsampling of the chrominance channels for compression need only be performed once for each frame in the GOP, as the result will be the same for each shifted position. All of the compression steps after quantization and all decompression steps before array multiplication may be omitted entirely. These steps are computationally expensive and are lossless, having no effect on the end result after decompression. For the purposes of this disclosure, “full” MPEG compression and decompression include all of the steps listed above. When some of those redundant or lossless steps are omitted, the resulting process is still MPEG compression and decompression for the purposes of this disclosure, but not “full” MPEG compression and decompression. In either case, MPEG compression comprises choosing a sequence of I-, P-, and B-frames (the sequence need not include all three frame types) and computing residual blocks and motion vectors for any P- and B-frames.

Preferably, but not necessarily, during the MPEG compression and decompression in accordance with an example embodiment of the invention the parameters controlling the MPEG processing are the same as were used to create the original MPEG video sequence. For example, the sequence of frame types, motion vector search range, motion vector resolution, bit rate, and rate control settings may be set to match the original MPEG video sequence. Alternatively, one or more settings may be altered. For example, the MPEG compression and decompression of step 103 of method 104 may be performed with a larger motion vector search range and a finer motion vector resolution than was the MPEG compression used to create the original MPEG video sequence.

In step 104 of method 100, each resulting decompressed GOP is shifted back to its nominal position. As with the original shifts, these shifts may be entirely conceptual, being accomplished by adjustments to indexing values used to read the arrays of data making up the frames.

In step 105, the resulting decompressed GOPs are combined to form a single improved GOP. In a preferred embodiment, the improved GOP is formed by averaging the resulting decompressed GOPs frame by frame and pixel by pixel. Other methods of combination may be used as well. For example, a weighted average may be used, wherein GOPs with smaller shift amounts are weighted differently in the weighted average than are GOPs with larger shift amounts.

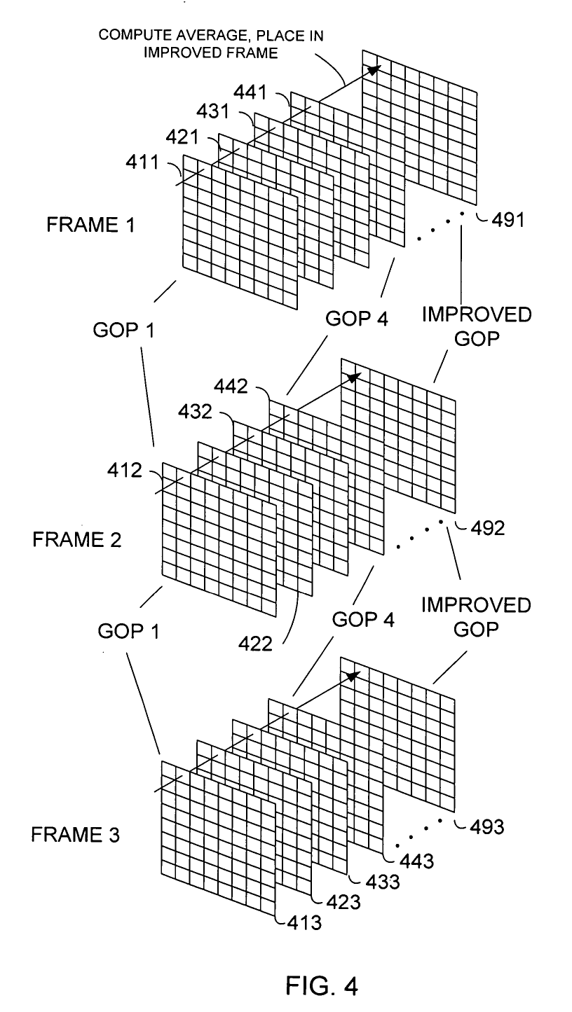

FIG. 4 illustrates the combination of the resulting decompressed GOPs in one example embodiment. Each grid array represents one resulting decompressed frame in an abbreviated GOP. Frames 411, 412, and 413 are subsequent frames in a first resulting decompressed GOP. Frames 421, 422, and 423 are subsequent frames in a second resulting decompressed GOP. Frames 431, 432, and 433 are subsequent frames in a third resulting decompressed GOP. Frames 441, 442, and 443 are subsequent frames in a fourth resulting decompressed GOP. In a complete application, many more frames and many more GOPs may be used. In FIG. 4, the GOPs have been shifted back to their initial spatial positions.

In the example of FIG. 4, a frame of the improved GOP is obtained by computing a pixel-by-pixel average of the corresponding frames in the resulting decompressed GOPS. In FIG. 4, frames 491, 492, and 493 are subsequent frames in the improved GOP.

Once the improved GOP has been obtained, it may be used for any purpose for which any decompressed rendition of the original MPEG GOP may be used. For example, it may be used as part of a display of the original MPEG video sequence. Preferably in this application, all GOPs in the video sequence would be processed in accordance with an embodiment of the invention. In such an application, the quality of the video display will be improved over a display formed by simply decompressing the original MPEG video sequence.

In another useful application, a user of a camera, computer, or other imaging device may be able to select a particular frame from the GOP to be used as a still photograph. This application is particularly appropriate for users of digital cameras. Many modern digital cameras can take still photographs having five or more megapixels per photograph. Such digital photographs can be used for making enlarged prints up to 16 by 20 inches or more with excellent quality.

Many modern digital cameras also enable a camera user to use the same camera to capture video clips or sequences. Due to the processing and storage requirements of digital video, many cameras can record video only at resolutions considerably lower than the resolution at which they can take still photographs. For example, a five megapixel digital camera may limit its video frames to the “VGA” size of 640×480 pixels, or about one third of a megapixel per frame. Such cameras often also enable the user to extract a particular frame of digital video for use as a still photograph. While each frame of digital video is a digital photograph, it is a much lower resolution photograph than the camera is otherwise capable of, and the user may be disappointed that the photograph does not appear sharp when it is enlarged for printing. In this application, improvement of the quality of digital video is especially valuable.

Often, a frame that is extracted from a video sequence for use as a still photograph is upsampled so that the resulting still photograph has a number of pixels comparable to the number in a still photograph taken directly by the camera. The upsampling is usually accomplished by interpolating between the existing pixels. Any of many different well-known interpolation methods may be used. This process upsampling is sometimes referred to as increasing the resolution of the photograph, even though no additional spatial details are actually revealed in the photograph.

A method in accordance with an example embodiment of the invention may include upsampling of a frame extracted from a video sequence for use as a still photograph. Preferably, the upsampling is performed before the MPEG compression and decompression of step 103 of FIG. 1, or after the combination of the resulting decompressed GOPs in step 107 of FIG. 1.

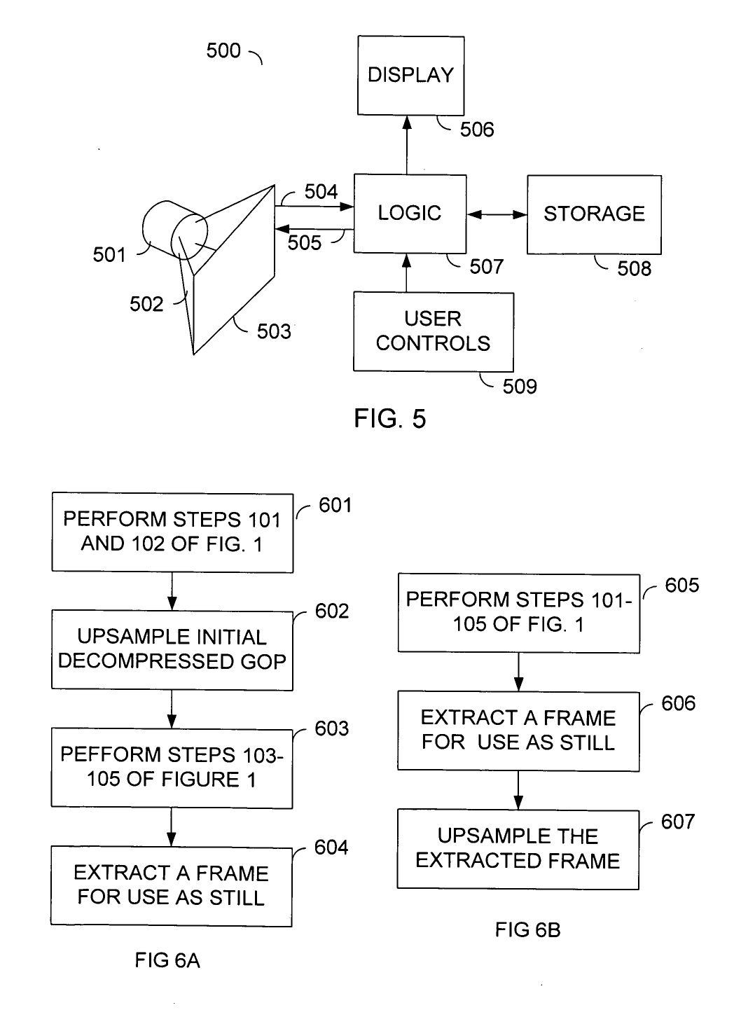

FIGS. 6A and 6B illustrate these two example sequences. At step 601 in FIG. 6A, steps 101 and 102 of the method of FIG. 1 are performed. At step 602, each frame in the initial decompressed GOP is upsampled. At step 603, steps 103-105 of the method of FIG. 1 are performed. At step 604, a frame is extracted for use as a still photograph. Upsampling before the MPEG compression and decompression results in a GOP with larger frames and consequently more computation involved in the compression and decompression, but may result in an improved extracted frame.

FIG. 6B illustrates an alternate example order of steps. At step 605, steps 101-105 of the method of FIG. 1 are performed. At step 606, a frame is extracted from the improved GOP, the frame to be used as a still photograph. At step 607, the extracted frame is upsampled.

A method in accordance with an example embodiment of the invention may be performed in a digital camera, computer, video phone, or other electronic imaging device capable of processing MPEG video. FIG. 5 depicts a block diagram of a digital camera 500, configured to perform a method in accordance with an example embodiment of the invention. In camera 500, a lens 501 collects light from a scene and redirects it 502 to form an image on an electronic array light sensor 503. Electronic array light sensor 503 may be, for example, a charge coupled device sensor (CCD) or another kind of sensor. Image signals representing the intensity of light falling on various pixels of sensor 503 are sent to logic 507. Logic 507 may send control signals 505 to sensor 503. Logic 507 may comprise circuitry for converting image signals 504 to digital values, computational logic, a microprocessor, and digital signal processor, memory, dedicated logic, or a combination of these or other components. A user of the camera may direct the operation of the camera through user controls 509, and camera 500 may display digital images on display 506. Storage 508 may comprise random access memory (RAM), read only memory (ROM), flash memory or another kind of nonvolatile memory, or a combination of these or other kinds of computer-readable storage media. Information stored in storage 508 may comprise digital image files, configuration information, or instructions for logic 507. Instructions for logic 507 may comprise a computer program that implements a method for improving MPEG video in accordance with an embodiment of the invention.

A method according to an example embodiment of the invention may also be performed by a computer, the computer executing instructions stored on a computer-readable storage medium. The computer-readable storage medium may be a floppy disk, a compact disk read only memory (CD-ROM), a digital versatile disk (DVD), read only memory (ROM), random access memory (RAM), flash memory, or another kind of computer-readable memory.

1. A method, comprising:
obtaining a compressed group of pictures from an MPEG video sequence;
decompressing the group of pictures to obtain an initial decompressed group of pictures;
for each of at least two shift positions, spatially shifting the initial decompressed group of pictures, and applying MPEG compression and decompression to the shifted group of pictures to obtain a resulting decompressed group of pictures for each shift position;
shifting each resulting decompressed group of pictures back to its initial spatial position; and
combining the resulting decompressed groups of pictures to obtain an improved group of pictures.

2. The method of claim 1, wherein 64 shift positions are used, including the initial position.

3. The method of claim 2, wherein the 64 shift positions cover a range of −4 to +3 pixels of shift from the initial position in a horizontal direction and −4 to +3 pixels of shift from the initial position in a vertical direction.

4. The method of claim 1, wherein combining the resulting decompressed groups of pictures further comprises computing a pixel-by-pixel average of corresponding frames from each group of pictures.

5. The method of claim 4, wherein the average is a weighted average.

6. The method of claim 1, further comprising displaying the improved group of pictures in a video sequence.

7. The method of claim 1, wherein all settings used for performing the MPEG compression and decompressions are the same as settings that were used to construct the original compressed group of pictures.

8. The method of claim 7, wherein the settings comprise a motion vector resolution, a motion vector search range, and a frame type sequence.

9. The method of claim 1, wherein one or more settings used for performing the MPEG compression and decompression differ from settings used to construct the original compressed group of pictures.

10. The method of claim 9, wherein a motion vector search range differs.

11. The method of claim 9, wherein a motion vector resolution differs.

12. The method of claim 9, wherein a frame type sequence differs.

13. The method of claim 9, wherein a bitrate differs.

14. The method of claim 9, wherein a rate control parameter differs.

15. The method of claim 1, further comprising:
extracting a particular frame from the improved group of pictures, and using the extracted frame as a still photograph.

16. The method of claim 15, further comprising upsampling that results in the still photograph comprising more pixels than are comprised in a frame of the initial decompressed group of pictures.

17. The method of claim 16, wherein the initial decompressed group of pictures is upsampled before step of spatially shifting the initial decompressed group of pictures and applying MPEG compression and decompression.

18. The method of claim 16, wherein the upsampling occurs after the step of combining the resulting decompressed groups of pictures.

19. The method of claim 1, wherein the MPEG compression and decompression comprises:
run-length coding of AC coefficients from a discrete cosine transform;
variable-length coding of coefficients from the discrete cosine transform; and
interpreting the variable-length and run-length codes to reconstruct the discrete cosine transform coefficients.

20. The method of claim 1, wherein during the MPEG compression and decompression, at least some lossless operations are omitted to improve computational efficiency.

21. An electronic device, comprising storage holding an MPEG video sequence and further comprising logic, the logic configured to perform the following method:
retrieving a group of pictures from the stored MPEG video sequence;
decompressing the group of pictures to obtain an initial decompressed group of pictures;
spatially shifting the group of pictures to at least two shift positions;
for each shift position, performing MPEG compression and decompression on the group of pictures to obtain a resulting decompressed group of pictures for each shift position; and
combining the resulting decompressed groups of pictures to obtain an improved group of pictures.

22. The electronic device of claim 21, wherein combining the resulting decompressed groups of pictures further comprises averaging corresponding frames of the groups of pictures pixel-by-pixel.

23. The electronic device of claim 21, wherein 64 shift positions are used.

24. The electronic device of claim 21, wherein the method further comprises displaying the improved group of pictures in a video sequence.

25. The electronic device of claim 21, wherein all settings used to perform the MPEG compression and decompression are the same as settings used to construct the original compressed group of pictures.

26. The electronic device of claim 25, wherein the settings comprise a motion vector resolution, a motion vector search range, and a frame type sequence.

27. The electronic device of claim 25, wherein one or more settings used to perform the MPEG compression and decompression differ from settings used to construct the original compressed group of pictures.

28. The electronic device of claim 21, wherein the method further comprises extracting a particular frame from the improved group of pictures for use as a still photograph.

29. The electronic device of claim 28, further comprising upsampling such that the resulting still photograph comprises more pixels that does a frame in the initial decompressed group of pictures.

30. The electronic device of claim 29, wherein the upsampling is applied to the initial decompressed group of pictures.

31. The electronic device of claim 29, where in the upsampling is applied after the step of combining the resulting decompressed groups of pictures.

32. The electronic device of claim 21, wherein the electronic device is a digital camera.

33. The electronic device of claim 21, wherein the electronic device is a computer.

34. A computer-readable storage medium storing instructions for performing the following method on an initial decompressed group of pictures obtained from an MPEG video sequence:
spatially shifting the group of pictures to at least two shift positions;
applying MPEG compression and decompression to the group of pictures in each shift position, thereby obtaining for each shift position a resulting decompressed group of pictures; combining the resulting decompressed groups of pictures to obtain an improved group of pictures.

35. The computer-readable storage medium of claim 34, wherein combining the resulting decompressed groups of pictures further comprises averaging corresponding frames in the groups of pictures.

36. The computer-readable storage medium of claim 34, wherein the method further comprises displaying the improved group of pictures in a video sequence.

37. The computer-readable storage medium of claim 34, wherein the method further comprises:
extracting a particular frame from the improved group of pictures; and
using the extracted frame as a still photograph.
